(19) United States
(12) Patent Application Publication
(10) Pub. No.: US 2020/0166227 A1
(43) Pub. Date: May 28, 2020

(54) SPRAY DEVICE

(71) Applicant: BOBSON HYGIENE INTERNATIONAL INC., New Taipei City (TW)

(72) Inventors: Cheng-Feng CHEN, New Taipei City (TW); Cheng-Chang CHEN, New Taipei City (TW)

(21) Appl. No.: 16/198,970

(22) Filed: Nov. 23, 2018

(51) Int. Cl. F24F 6/14; B05B 7/24

(52) U.S. Cl. CPC F24F 6/14; B05B 12/002; B05B 7/2464; B05B 7/2424

(57) ABSTRACT

A spray device includes a base seat unit, a liquid container having a liquid-receiving space, a nozzle unit including a nozzle and a drawing tube, and an electric gas pump. The nozzle has an outlet, and a gas inlet and a liquid entrance that are in spatial communication with the outlet. The drawing tube spatially interconnects the liquid-receiving space and the liquid entrance. The electric gas pump has a gas supplying hole spatially communicated with the gas inlet. The electric gas pump is operable to provide a gas into the gas inlet through the gas supplying hole, such that the liquid stored in the liquid-receiving space is drawn into the liquid entrance through the drawing tube and thereafter exits the outlet together with the gas.

### FIELD

The disclosure relates to a spray device, and more particularly to an electrically operated spray device.

### BACKGROUND

A conventional spray device includes a container that stores a liquid and pressurized gas, and sprays the liquid therefrom via the pressure difference between pressure inside the container and the atmospheric pressure, releasing the liquid as in mist form. While mechanically simple, this type of spray device is undesirable for flight transport, as the pressure difference becomes even greater with increasing altitude, making it extremely hazardous.

Another conventional spray device has a core material and a vibrating module. After the core material absorbs the liquid, the vibrating module generates high-frequency vibration, oscillating the core material to vaporize the liquid into mist when released. While this type of spray device does not have pressurized gas stored therein, the vibrating module itself is relatively expensive.

### SUMMARY

Therefore, an object of the disclosure is to provide a spray device that can alleviate the drawback of the prior art.

According to the disclosure, the spray device includes a base seat unit, a liquid container, a nozzle unit, and an electric gas pump. The liquid container is mounted to the base seat unit, and has a liquid-receiving space that is adapted for storing a liquid.

The nozzle unit is mounted to the liquid container, and includes a nozzle and a drawing tube. The nozzle has an outlet, a gas inlet that is in spatial communication with the outlet, and a liquid entrance that is in spatial communication with the outlet. The drawing tube spatially interconnects the liquid-receiving space and the liquid entrance.

The electric gas pump is mounted to the base seat unit and has a gas supplying hole that is spatially communicated with the gas inlet of the nozzle. The electric gas pump is operable to provide a gas into the gas inlet of the nozzle through the gas supplying hole, such that the liquid stored in the liquid-receiving space of the liquid container is drawn into the liquid entrance through the drawing tube and thereafter exits the outlet of the nozzle unit together with the gas.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of a first embodiment of a spray device according to the disclosure;

FIG. 2 is a fragmentary exploded perspective view of the first embodiment;

FIG. 3 is another fragmentary exploded perspective view of the first embodiment;

FIG. 4 is a sectional view of the first embodiment, illustrating a nozzle unit and a liquid container of the first embodiment;

FIG. 5 is a schematic diagram of the first embodiment;

FIG. 6 is a fragmentary assembled perspective view of the first embodiment with a front cover being omitted;

FIG. 7 is an assembled perspective view of the first embodiment, illustrating the front cover being pivotally opened upward;

FIG. 8 is another assembled perspective view of the first embodiment with a rear cover being omitted;

FIG. 9 is a perspective view of a second embodiment of the spray device according to the disclosure; and

FIG. 10 is a fragmentary exploded perspective view of the second embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

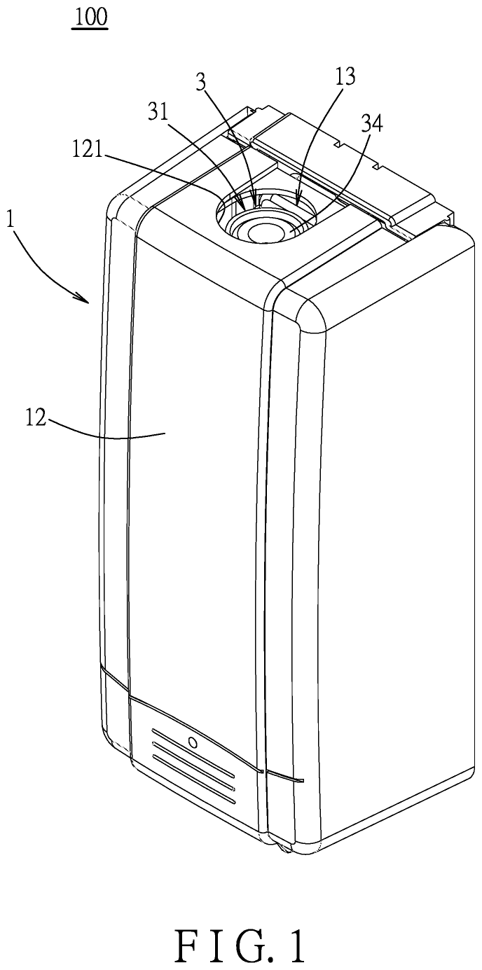

Referring to FIGS. 1 to 3, a first embodiment of a spray device 100 according to the disclosure includes a base seat unit 1, a liquid container 2, a nozzle unit 3, an electric gas pump 4, and a control unit 6.

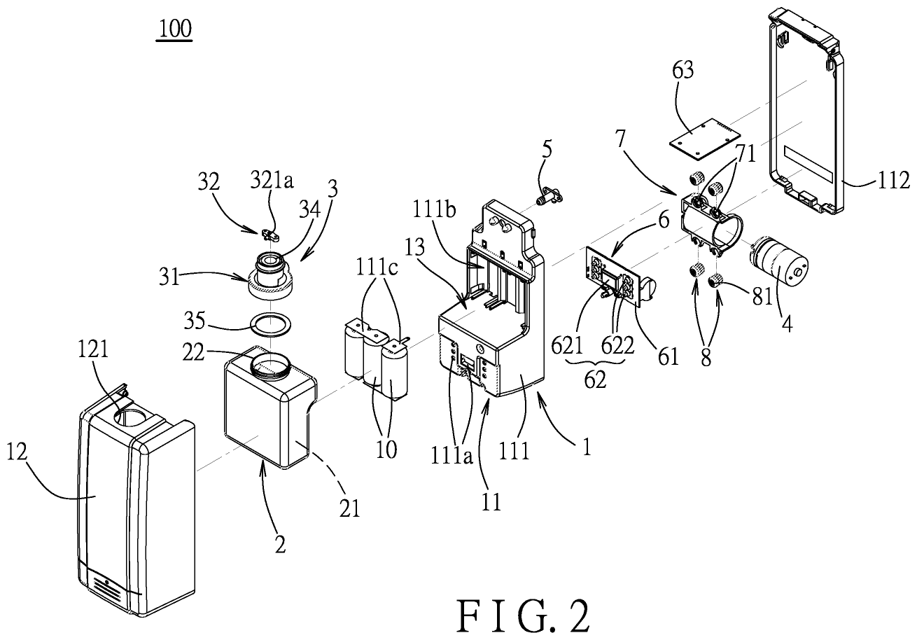

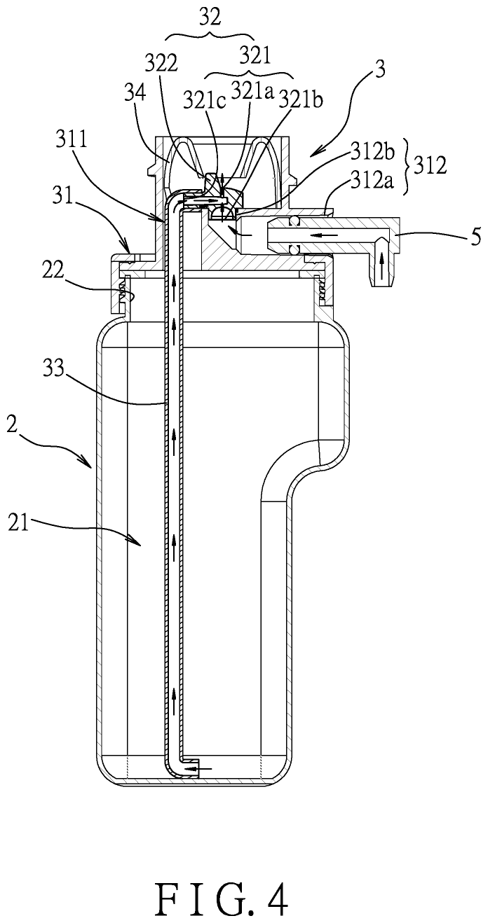

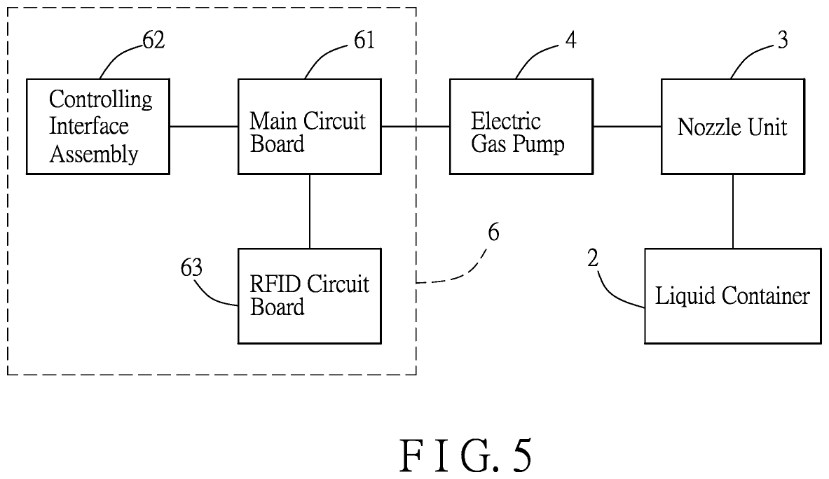

Referring to FIGS. 2 to 5, in the first embodiment, the base seat unit 1 has a base seat 11, and a front cover 12 that covers and is connected to the base seat 11. The base seat 11 has a seat body 111, a rear cover 112 that is connected to a rear end of the seat body 111, and a first receiving space 113 that is cooperatively defined by the seat body 111 and the rear cover 112, and that receives the electric gas pump 4 and the control unit 6. The base seat 11 and the front cover 12 cooperatively define a second receiving space 13.

The liquid container 2 is mounted to the base seat unit 1, is received in the second receiving space 13, and has a liquid-receiving space 21 that is adapted for storing a liquid, and a container opening 22 that is fluidly communicated with the liquid-receiving space 21. In the first embodiment, the liquid is a type of air refreshers, but it may be a cleaning solution in other embodiment.

The nozzle unit 3 is mounted to the liquid container 2, and includes a coupling seat 31, a nozzle 32, and a drawing tube 33. The coupling seat 31 is coupled to the container opening 22 of the liquid container 2, and is formed with a tube hole 311 that is fluidly communicated with the liquid-receiving space 21 and a gas flow pathway 312 that has a gas entrance 312a and a gas exit 312b. The nozzle 32 is mounted on top of the coupling seat 31, and is formed with an inner flow pathway 321. The inner flow pathway 321 has an outlet 321a, a gas inlet 321b that is in spatial communication with the outlet 321a, and a liquid entrance 321c that is in spatial communication with the outlet 321a. Correspondingly, the gas inlet 321b is fluidly communicated with the gas exit 312b of the coupling seat 31. The drawing tube 33 spatially interconnects the liquid-receiving space 21 and the liquid entrance 321c of the nozzle 32, and is adapted for guiding the liquid thereto. Specifically, the drawing tube 33 extends into the liquid-receiving space 21 through the tube hole 311 of the coupling seat 31. In addition, in the first embodiment, the front cover 12 further has an exposing hole 121 that exposes the outlet 321a of the nozzle 32.

The nozzle unit 3 further includes an annular limiting member 34 that surrounds the outlet 321a of the nozzle 32. The nozzle 32 is further formed with a guiding block 322 that is adjacent to the outlet 321a. Both the limiting member 34 and the guiding block 322 serve to restrict the direction in which gas and mist exit the outlet 321a. Furthermore, in this embodiment, the nozzle unit 3 further has an annular washer 35 that is clamped between the coupling seat 31 and the liquid container 2, and that prevents leakage of the liquid through a gap between the coupling seat 31 and the container opening 22.

The electric gas pump 4 is mounted to the base seat unit 1, is disposed in the first receiving space 113, and is adapted for providing gas to the nozzle 32. The electric gas pump 4 has a gas supplying hole 41 that is spatially communicated with the gas inlet 321b of the nozzle 32. The electric gas pump 4 is operable to provide the gas into the gas inlet 321b of the nozzle 32 through the gas supplying hole 41, such that the liquid stored in the liquid-receiving space 21 of the liquid container 2 is drawn into the liquid entrance 321c through the drawing tube 33 and thereafter exits the outlet 321a of the nozzle unit 3 together with the gas. To be more specific, when the gas pump 4 provides the gas to the nozzle 32, the gas exits the nozzle 32 through the outlet 321a thereof. When the gas is flowing through the inner flow pathway 321 swiftly, pressure of the inner flow pathway 321 of the nozzle 32 becomes smaller than atmospheric pressure, such that the liquid in the liquid-receiving space 21 becomes easily drawn into the liquid entrance 321c through the drawing tube 33 and thereafter exits the outlet 321a of the nozzle 32 as mists. With that in mind, the spray device 100 does not need to store pressurized gas therein for driving movement of the liquid out of the liquid-receiving space 21.

In this embodiment, the spray device 100 further includes a connecting member 5, which has one end connected to the coupling seat 31 and an opposite end connected to a connecting tube (not shown). As such, the gas supplying hole 41 of the gas pump 4 is fluidly communicated to the gas inlet 321b of the nozzle 32 through the connecting tube, the connecting member 5 and the gas flow pathway 312 of the coupling seat 31, but may be different in other embodiments.

The control unit 6 is mounted to the first receiving space 113 of the base seat unit 1, is electrically coupled to the electric gas pump 4, and is operable to control the electric gas pump 4. The control unit 6 includes a main circuit board 61, and a controlling interface assembly 62 that is electrically coupled to the main circuit board 61. In the first embodiment, the controlling interface assembly 62 includes a display monitor 621 and a plurality of control buttons 622. The seat body 111 of the base seat 11 has a plurality of revealing holes 111a that extend therethrough for exposing the display monitor 621 and the control buttons 622, such that a user may operate the control unit 6 from the outside for controlling gas pumping frequency, amount, etc. In addition, in this embodiment, the control unit 6 further includes a radio-frequency identification (RFID) circuit board 63 that is mounted in the first receiving space 113 and that is electrically connected to the main circuit board 61. The RFID circuit board 63 is used to control the amount of mist released at a given time. The specific technology behind RFID is a known art, and will not be discussed further in this specification.

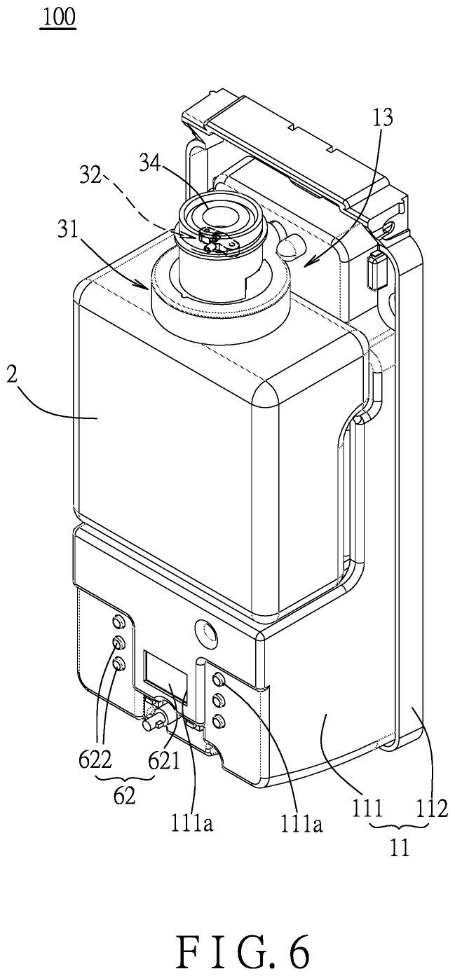

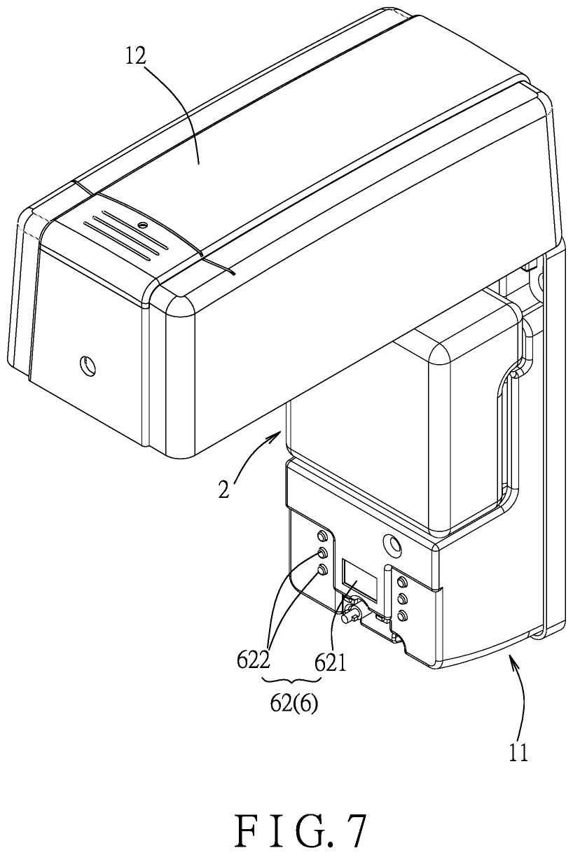

Referring to FIGS. 6 and 7, in this embodiment, the front cover 12 is pivotally connected to the base seat 11, so that the user can easily flip the front cover 12 to operate the control unit 6 through the controlling interface assembly 62.

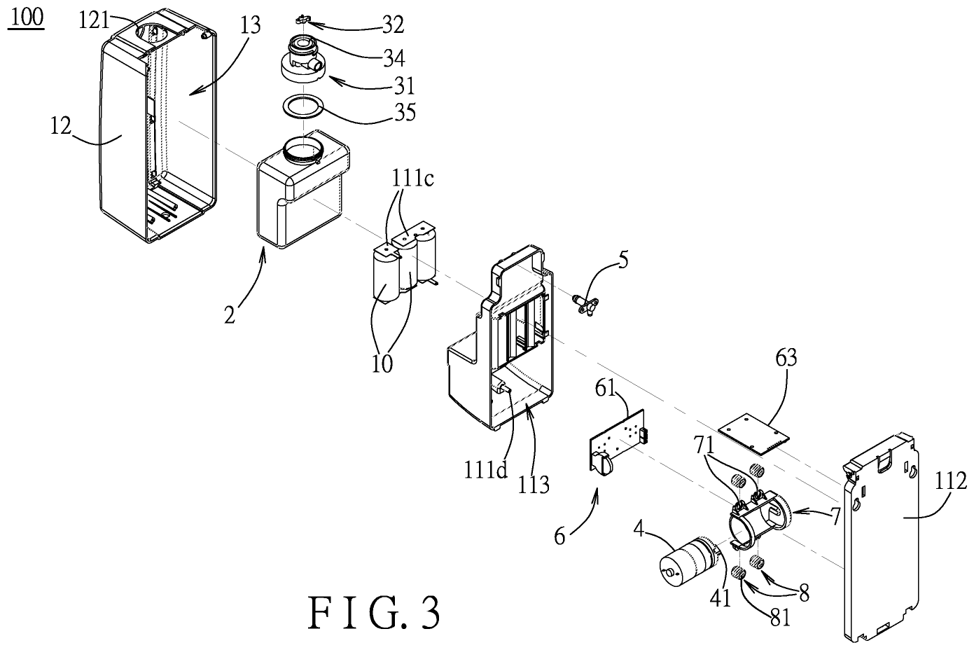

Referring back to FIGS. 2 and 3, in this embodiment, the seat body 111 of the base seat 11 further has a battery slot 111b that is in spatial communication with the second receiving space 13 and that is adapted for installation of a plurality of batteries 10, and a plurality of electrical connection members 111c that are disposed in the battery slot 111b and that are electrically coupled to the main circuit board 61 for transmitting electric power from the battery 10 to the main circuit board 61. It should be noted that in other embodiment, the main circuit board 61 may draw electric power from other types of power sources instead of batteries.

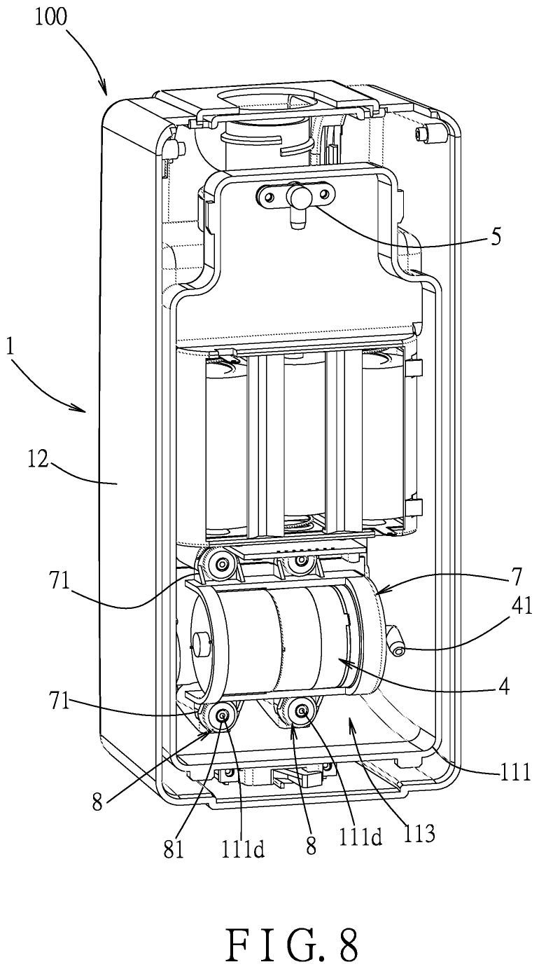

In addition, referring to FIG. 8, in the first embodiment, the seat body 111 of the base seat unit 1 is further formed with a plurality of supporting poles 11d disposed in the first receiving space 113. The spray device 100 further includes a gas pump frame 7 and a plurality of damping elastic members 8 connected between the electric gas pump 4 and gap pump frame 7. In this embodiment, the damping elastic members 8 are made of materials such as silica gel, but may simply be replaced with resilient materials such as springs in other embodiments. The gas pump frame 7 is disposed for holding the electric gas pump 4 in place, and has a plurality of fixing structures 71. Each of the damping elastic members 8 extends through a respective one of the fixing structures 71 of the gas pump frame 7, and is formed with an installation hole 81. Each of the supporting poles 111d of the seat body 111 extends through the installation hole 81 of a respective one of the damping elastic members 8, and the elastic members 8 are secured to the supporting poles 111d via screws (not shown). In other words, the gas pump frame 7 and the damping elastic members 8 are connected between the electric gas pump 4 and the base seat unit 1, such that the damping elastic members 8 are capable of absorbing vibration and noise caused by operation of the electric gas pump 4 toward the base seat unit 1.

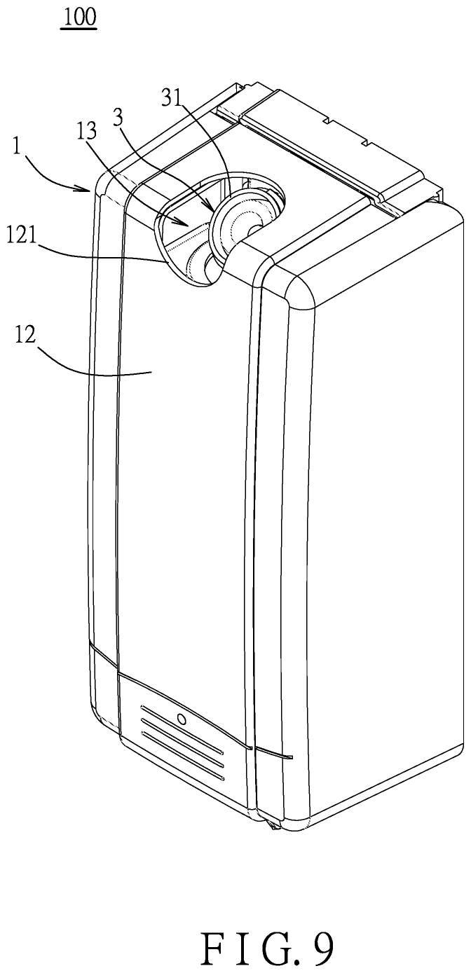

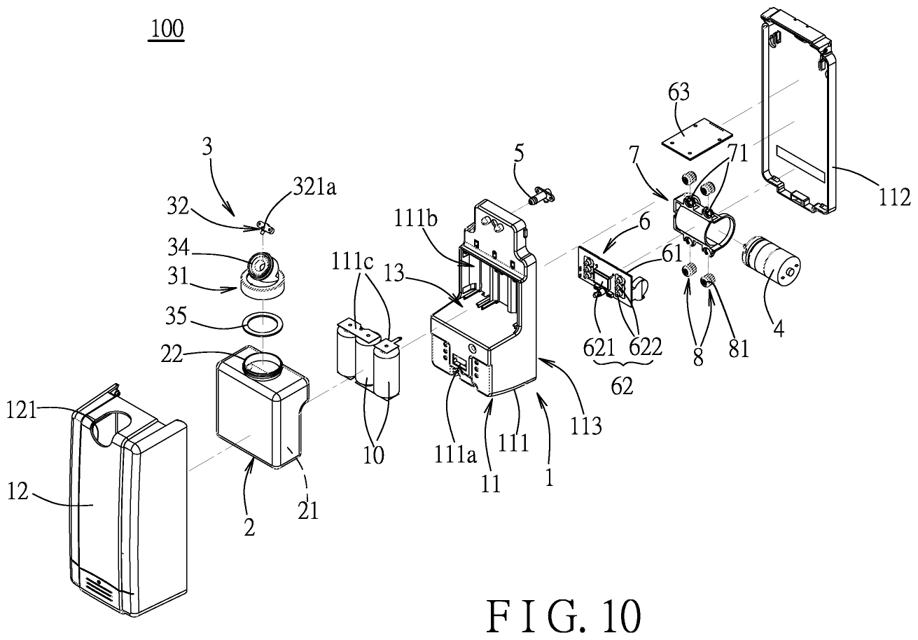

Referring to FIGS. 9 and 10, a second embodiment of the spray device 100 is similar to that of the first embodiment, with the following differences. In the second embodiment, the coupling seat 31 and the outlet 321a of the nozzle 32 are angled, facing forwardly upward instead of facing directly upward like that of the first embodiment. In addition, the exposing hole 121 of the front cover 12 is accordingly adjusted to properly expose the outlet 321a.

Overall, by utilizing the electric gap pump 4 to provide the gas to the nozzle unit 3, the spray device 100 does not need to store pressurized gas, such that it can be carried by flight without safety concerns. The spray device 100 is also economical for not having to utilize vibrating module.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A spray device comprising:
a base seat unit;
a liquid container mounted to said base seat unit, and having a liquid-receiving space that is adapted for storing a liquid;
a nozzle unit mounted to said liquid container, and including
a nozzle that has an outlet, a gas inlet in spatial communication with said outlet, and a liquid entrance in spatial communication with said outlet, and
a drawing tube that spatially interconnects said liquid-receiving space and said liquid entrance; and
an electric gas pump mounted to said base seat unit and having a gas supplying hole that is spatially communicated with said gas inlet of said nozzle;
wherein said electric gas pump is operable to provide a gas into said gas inlet of said nozzle through said gas supplying hole, such that the liquid stored in said liquid-receiving space of said liquid container is drawn into said liquid entrance through said drawing tube and thereafter exits said outlet of said nozzle unit together with the gas.

2. The spray device as claimed in claim 1, further comprising a control unit that is electrically coupled to said electric gas pump and that is operable to control said electric gas pump.

3. The spray device as claimed in claim 2, wherein said control unit includes a main circuit board, and a controlling interface assembly that is electrically coupled to said main circuit board.

4. The spray device as claimed in claim 3, wherein said controlling interface assembly includes a display monitor and a plurality of control buttons.

5. The spray device as claimed in claim 4, wherein said base seat unit includes:
a base seat that has a first receiving space receiving said electric gas pump and said control unit, and at least one revealing hole exposing said display monitor and said control buttons; and
a front cover that is connected to said base seat.

6. The spray device as claimed in claim 5, wherein:
said front cover and said base seat cooperatively define a second receiving space that receives said liquid container; and
said front cover has an exposing hole that exposes said nozzle.

7. The spray device as claimed in claim 6, wherein said base seat further has:
a battery slot that is in spatial communication with said second receiving space and that is adapted for installation of at least one battery; and
a plurality of electrical connection members that are disposed in said battery slot and that are electrically coupled to said main circuit board for transmitting electric power from the at least one battery to said main circuit board.

8. The spray device as claimed in claim 1, further comprising a plurality of damping elastic members that are connected between said electric gas pump and said base seat unit.

9. The spray device as claimed in claim 5, wherein said front cover is pivotally connected to said base seat.
